(19) United States
(12) Patent Application Publication
(10) Pub. No.: US 2002/0147036 A1
(43) Pub. Date: Oct. 10, 2002

(54) Auxiliary charging device for a mobile phone

(76) Inventors: Junji Taguchi, Tokyo (JP); Manabu Ogasawara, Tokyo (JP)

Correspondence Address: DARBY & DARBY P.C., POST OFFICE BOX 5257, NEW YORK, NY, 10150-5257, US

(21) Appl. No.: 09/829,712

(22) Filed: Apr. 10, 2001

(51) Int. Cl. H04M 1/00

(52) U.S. Cl. 455/573; 455/557

(57) ABSTRACT

A mobile phone auxiliary charging connector charges an internal battery in a mobile phone by connecting DC power from a USB port of a portable or desktop personal computer to the charging connector of the mobile phone. The cable of the mobile phone auxiliary charging connector connects the ground and 5-volt terminals of a plug inserted into the USB port to corresponding pins of a mobile phone connector plug.

### BACKGROUND TO THE INVENTION

The present invention relates to an auxiliary charging device that is used for charging a secondary battery that is internalized in a mobile phone.

Referring to FIG. 6, a prior art AC adapter 50 and a dedicated charging device 60 are used for the charging of a secondary battery internal to a mobile phone. AC adapter 50 includes a plug 51 that connects to an outlet 40 supplying AC power at, for example, 120 volts. A power cable 52a connects the power from the plug 51 to an AC/DC converter 53. The AC/DC converter 53 converts the 120 VAC to DC and steps down the voltage to a lower voltage of, for example, 5.0 VDC. A power cable 52b connects the DC voltage to a connector plug 54. The connector plug is 54 is inserted into a connector socket 46 of a mobile phone 45 to charge the battery therein.

Similarly, the dedicated charging device 60 converts the DC power and steps down the voltage to, for example, 5.0V by AC/DC converter 53, and supplies the DC power connector socket 46 of mobile phone 45.

However, miniaturization of the AC/DC converter 53 of AC adapter 50 and dedicated charging device 60 is difficult. It is equally difficult to decrease the weight of these devices. As a result, AC adapter 50 and dedicated charging device 60 are often larger than the body of the mobile phone body 45. This makes it difficult to carry these devices.

However, if AC adapter 50 and dedicated charging device 60 are not on hand, then nothing can be done when the battery runs out suddenly when one is out or at the office.

Emergency charging means is often performed, when AC adapter 50 and dedicated charging device 60 are not on hand, using a battery charging device, a hand crank generator charging device, or an additional dedicated charging device and adapter and the like.

For example, with the battery charging device, although this is convenient, batteries are necessary, and if batteries are not available, the phone cannot be charged. In addition, with the hand crank generator, although charging can be conducted anywhere, the charging time is long, and charging is tiring. Furthermore, an additional dedicated charging device and adapter have good charging performances, but the price is high.

### OBJECT AND SUMMARY OF THE INVENTION

The present invention considers the current situation as described above. The object of the present invention is to provide an auxiliary charging device for a mobile phone in which a mobile phone can be charged without requiring an AC adapter and dedicated charging device.

In order to solve the problems described above, the present invention is a mobile phone auxiliary charging device for charging a secondary battery inside a mobile phone. The charging device includes a first connection part that connects to a bus terminal of an electronic device equipped with a universal serial bus interface. A second connection part of the charging device connects to the mobile phone. A transmission cable connects the first connection part and the second connection part.

The aforementioned mobile phone auxiliary charging device can supply a power line from a personal computer as the aforementioned electronic device.

Briefly stated, the present invention provides a mobile phone auxiliary charging connector which charges an internal battery in a mobile phone by connecting DC power from a USB port of a portable or desktop personal computer to the charging connector of the mobile phone. The cable of the mobile phone auxiliary charging connector connects the ground and 5-volt terminals of a plug inserted into the USB port to corresponding pins of a mobile phone connector plug.

According to an embodiment of the invention, there is provided a mobile phone auxiliary charging device for charging a secondary battery in a mobile phone, comprising: a first connection part, said first connection part connecting to a universal serial bus terminal of an electronic device, a second connection part, the second connection part connecting to said mobile phone, and a cable connecting corresponding power terminals of said first connection part and said second connection part.

The above, and other objects, features, and advantages of the present invention will become apparent from the following description read in conjunction with the accompanying drawings, in which like reference numerals designate the same elements.

### BRIEF DESCRIPTION OF THE DRAWINGS

FIG. 1 is a drawing showing a secondary battery of a mobile phone being charged by a mobile phone auxiliary charging connector that is the embodiment of the present invention.

FIG. 2 is an electrical block diagram of the above described mobile phone auxiliary charging connector.

FIG. 3 is an exterior view of a mobile phone auxiliary charging connector as described above.

FIG. 4 is an end view of a connector plug on the mobile phone side of the mobile phone auxiliary charging connector of FIG. 3.

FIG. 5 is a modification example of the above described mobile phone auxiliary charging connector.

FIG. 6 is a perspective drawing of an AC adapter and a dedicated charging device used in the prior art for charging a secondary battery internal to a mobile phone.

### DESCRIPTION OF TEIE PREFERRED EMBODIMENTS

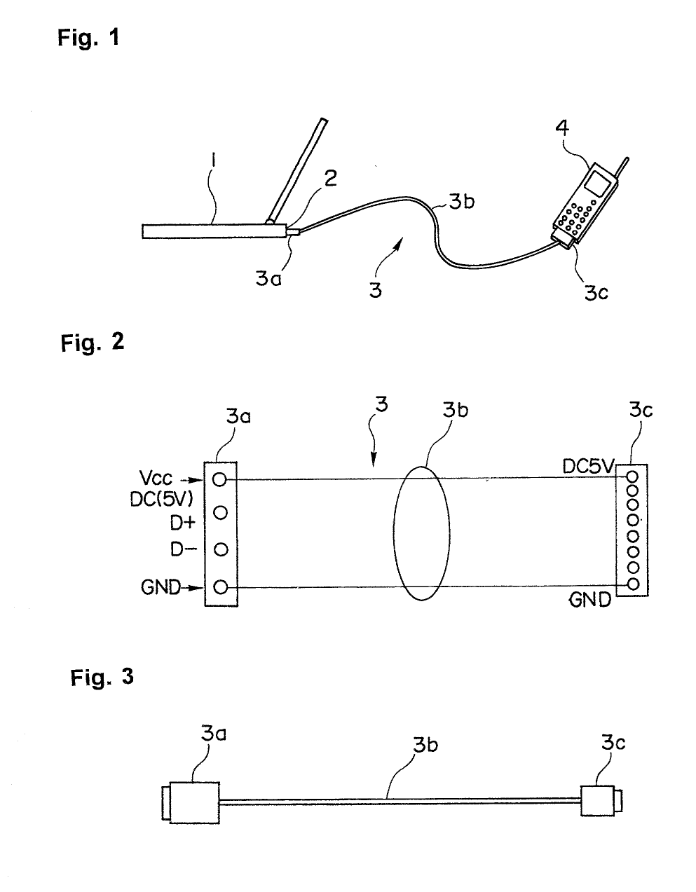

Referring to FIG. 1, a mobile phone charging connector 3 supplies 5.0 VDC to a secondary battery of a mobile phone 4. The power is supplied from a universal serial bus (USB) terminal 2 of a portable personal computer 1. When the portable personal computer 1 is available at home or at work, charging of the mobile phone 4 can be done easily.

USB terminal 2 of portable personal computer 1 can not only connect several peripheral devices in a daisy chain as in the prior art, but it can also connect them by branching. The cables and connectors for connecting to the USB terminal 2 can be miniaturized.

Referring to FIG. 2, the electrical construction of mobile phone charging connector 3 that is connected to this USB terminal 2 is shown. It will be noted that the mobile phone charging connector 3 connects the ground (GND) and Vcc (DC5V) of the USB connector plug 3a pin to pin to corresponding pins of the mobile phone connector plug 3c.

Referring to FIG. 3, the mobile phone charging connector 3 includes at one end of the USB connector plug 3a that connects to the USB terminal 2 of the portable personal computer 1. A cable 3b connects the corresponding pins of the USB connector plug 3a to mobile phone connector plug 3c that connects to a connector socket on mobile phone 4.

A power supply line (Vcc, GND) for outputting the above described DC 5.0V and data lines (D+, D−) are connected to the USB connector plug 3a. Of these lines, the power supply line is connected to mobile phone connector plug 3c to supply DC power at 5.0V. The USB of portable personal computer 1 supplies a voltage of DC 5.0V to mobile phone 4 via a standard internal USB interface and the power supply line described above. As a result, because DC 5.0V is supplied to mobile phone 4 from portable personal computer 1 via mobile phone charging connector 3, the secondary battery inside the mobile phone 4 is charged.

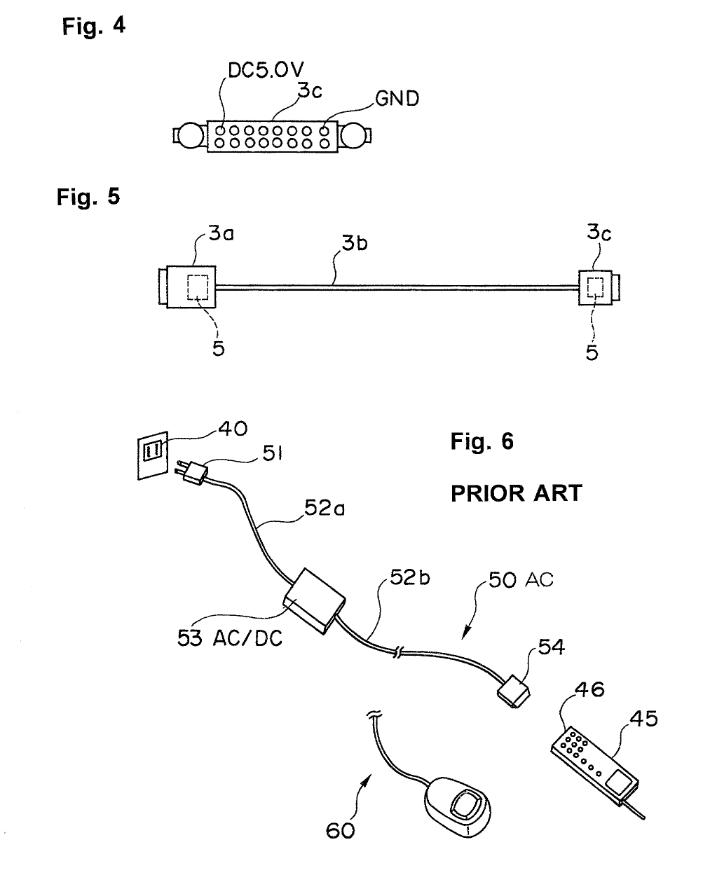

Referring to FIG. 4, connector plug 3c on the side of mobile phone 4 is generally a 16-pin plug. For example, a DC 5.0 V pin and a ground GND pin can be connected to the first pin and the 8th pin, respectively.

The invention relies on the fact that the internal battery in the portable personal computer 1 generally has a significantly greater capacity than the internal battery in the typical mobile phone 4. Thus, the mobile phone 4 can be charged without rapid discharge of the internal battery in the portable personal computer 1. In many cases, a user is only interested in powering the mobile phone 4 long enough to make one or two phone calls. After the calls are made, the user can disconnect the mobile phone charging connector. In this event, very little power is taken from the portable personal computer. From experiments, the current during charging is 120-200 mA. No problems are foreseen in mobile phone 4 or portable personal computer 1. The maximum supply current of the USB standard is 500 mA. This is within the allowable range for charging mobile phone lithium batteries which are currently mainstream. As a result, safe charging is possible.

Referring to FIG. 5, in order to prevent overcharging and the like, a conventional safety circuit can be embedded in the USB connector plug 3a and/or the mobile phone connector plug 3c of mobile phone charging connector 3.

According to the present invention, even if a dedicated charging device and AC adapter are not on hand, a personal computer at the office and the like can act as a charging device for a mobile phone. As long as there is a working personal computer having a USB port, charging of the mobile phone is possible.

Furthermore, charging from a notebook computer when going out is possible. An inexpensive auxiliary charging function that is constructed only from a connector can be provided.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A mobile phone auxiliary charging device for charging a secondary battery in a mobile phone, comprising:
a first connection part;
said first connection part connecting to a universal serial bus terminal of an electronic device;
a second connection part;
said second connection part connecting to said mobile phone; and
a cable connecting corresponding power terminals of said first connection part and said second connection part.

2. A mobile phone auxiliary charging device according to claim 1, wherein said an electronic device includes a personal computer.

3. A mobile phone auxiliary charging device according to claim 2 wherein said personal computer includes a portable personal computer.
